(19) United States
(12) Patent Application Publication
(10) Pub. No.: US 2016/0330985 A1
(43) Pub. Date: Nov. 17, 2016

(54) Process of producing partially dehydrated shredded cabbage suitable for making egg rolls

(71) Applicant: Jianming Ni, Greensboro, NC (US)

(72) Inventor: Jianming Ni, Greensboro, NC (US)

(21) Appl. No.: 14/545,517

(22) Filed: May 15, 2015

(51) Int. Cl. A23B 7/02

(52) U.S. Cl. CPC A23B 7/0205; A23V 2002/00

(57) ABSTRACT

Cabbage is dehydrated to a desirable moisture content to retain its color, texture, and taste without generating undesirable amount of liquid and is suitable for making filling of egg rolls. The cabbage is cut into shredded strips which is first tenderized in hot water, or alternatively by squeezing with mechanical compression, centrifugal extraction, or mixing with salt, to remove some moisture content. The product is then washed in cold water, followed by further removal of its moisture content with centrifugal extraction. The product is finally dehydrated and cooled in a cooling chamber under vacuum pressure.

### BACKGROUND OF THE INVENTION

1. Field of the Invention

This invention relates to a continuous mass production method of processing fresh vegetable and particularly cabbage suitable for making egg rolls for either commercial or domestic purposes.

2. Background Art

In making egg rolls, especially vegetable egg rolls, a large amount of vegetable such as fresh cabbage is required as a main ingredient of the filling. The cabbage is necessarily cut or chopped into small pieces in order to facilitate the enclosing of the filling in the enveloping wrap of the egg roll. To enable the production of a large amount of egg rolls particularly in a commercial scale for sale to the consumer throughout the year, it is preferable to provide chopped up fresh cabbage in a ready-to-use form in bulk suitable for making egg rolls. The cabbage cut or chopped into small pieces can be packaged and stored in a freezer such that it may be conveniently and readily be used for making egg roll filling by either consumers for domestic use or to restaurants or other food establishments for producing a large amount of egg rolls. The cut or chopped cabbage product must have a long storage and shelf life without spoilage and it must also have a suitable moisture content to retain its delectable characteristic texture and taste.

It has been problematic in such process, due to that the temperature of cut or chopped cabbage product naturally rises to an inherent temperature of 30 to 45 degree C. Thus, it is necessary to place the cut or chopped cabbage product in separate large trays for locating in a cooler to bring its temperature slowly down to 0 degree C. in order that it can be put in the final packaging of various sizes for placing in a freezer for sale. Such cooling process is very time consuming and may take up to 4 to 5 hours to achieve and it is labour intensive. Therefore, it is not conducive to a continuous mass production process. Also, the moisture content of the cut or chopped cabbage in such process is rather high so that the it has a short shelf life and subject to a large amount of spoilage. Furthermore, the high moisture content of cut or chopped cabbage product would generate an undesirable amount of liquid when it is mixed with other ingredients in the egg rolls filling resulting in producing not delectable soggy egg rolls.

### SUMMARY OF THE INVENTION

It is a principal object of the present invention in provide partially dehydrated fresh cabbage in bulk form ready for use in making filling of egg rolls.

It is another object of the present invention to provide partially dehydrated shredded fresh cabbage having a particular moisture content to retain its delectable characteristic texture and taste.

It is another object of the present invention to provide partially dehydrated shredded fresh cabbage having a long storage and shelf life.

It is yet another object of the present invention to provide shredded cabbage which is conducive to mix with other ingredients in the making of egg rolls filling without generating water in the mixture.

### BRIEF DESCRIPTION OF THE DRAWING

FIG. 1 shows a schematic flow diagram illustrating the continuous mass production process of producing fresh shredded cabbage according to the present invention suitable for making egg rolls.

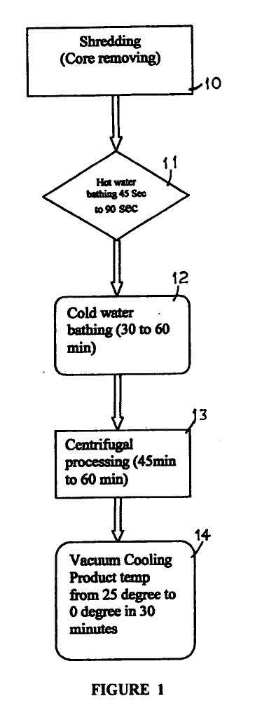

### DETAILED DESCRIPTION OF THE PREFERRED EMBODIMENTS

According to the present invention, heads of fresh cabbage with the core removed are mechanically shredded in a shredder 10 to strips preferably of 1 to 4 inches long and ⅛ inch to ¼ inch wide. The shredding process breaks down the natural fibrous structure of the cabbage to enhance the subsequent removal of its moisture content and the strips are also in a physical size suitable for making egg rolls filling. The product of shredded cabbage strips is then blenched in hot water having a temperature of about 70 to 85 degree C. in a blenching bath 11 for a period of approximately 45 to 90 seconds to partially cook the shredding to a tender state with its water content initially removed. The initial water content removal may alternatively be achieved by centrifugal extraction, applying heat, squeezing by mechanical compression, or marinating with salt. The goal of this process is to prepare the product ready to mix with other ingredient and seasoning in making the egg roll filling without it generating liquid. The preference of these alternative methods depends largely on the different textures of the cabbage in different times of the year. For example, when the cabbage is fresh and having a hard texture in the fall season after it is freshly harvested, blenching in hot water is preferred while the other alternative method may be employed in the off seasons when some of the moisture content of the cabbage has already been lost.

After the blenching process, the product is then subjected to a cold water treatment in a cold water bath 12 for 30 to 60 minutes with the water temperature relatively colder than the hot water in the blenching bath 11 so as to preserve the color and texture of the product and to wash off particularly any salt residue if it has been marinated with salt in the initial water content removal step. The product at this stage has a water content of from 85% to 95%.

The product is then subjected to centrifugal processing for 45 minutes to 60 minutes in a centrifuge in a centrifugal chamber 13 to further reduce its water content of 2% to 30%.

The cabbage product is finally cooled in a vacuum chamber 14 having a vacuum pressure of from 500 pa to 600 pa so as to reduce the final dehydrated cabbage product to a desirable moisture content of 70% to 90% and to retain its fresh texture and taste; and it would generate a minimum amount of liquid when it is mixed with other ingredients and seasoning in making the egg rolls filling. The vacuum chamber 14 may be in the form of a rotating drum which continuously tosses the shredded product while it is being cooled rapidly under the vacuum pressure. Typically, 600 lbs of shredded cabbage can be cooled to 0 degree C. in approximately 30 minutes in this manner.

The cooled dehydrated product is then placed into final containers or retail packaging bags for locating in a freezer for sale to the commercial establishments and/or individual consumers for making egg rolls.

The entire process may be carried out in a continuous mass production process conveniently and readily.

While the present invention has been shown and described in the preferred embodiment thereof, it will be apparent that various modifications can be made therein without departing from the spirit or essential attributes thereof, and it is desired therefore that only such limitations be placed thereon as are imposed by the appended claims.

What is claimed is:

1. A method of producing partially dehydrated shredded cabbage comprising:
mechanically cutting cabbage to a product of chopped pieces;
blenching said product in a hot water bath to a tender state having a desirable color and texture;
immersed said product in a cold water bath to retain said color and texture;
subjecting said product to a centrifugal process to remove moisture content further;
cooling and dehydrating said product under vacuuming pressure to a final partially dehydrated product; and
packaging said partially dehydrated product in containers for sale to users for making egg rolls filling.

2. A continuous mass production method of producing partially dehydrated shredded cabbage suitable for making egg rolls, comprising:
mechanically shredding cabbage to a product of shredded strips;
tenderising said product to a tender state having a desirable color and texture;
immersing said product after tenderising in a cold water bath;
removing moisture content of said product in a centrifuge;
cooling and dehydrating said product under vacuum pressure to a final product having a predetermined dehydrated state; and
packaging said final product in individual packaging for placing in a freezer for sale to users for making egg rolls filling.

3. A continuous mass production method according to claim 2 wherein said tendering step is carrying out by blenching said product in hot water of from 70 to 85 degree C.

4. A continuous mass production method according to claim 2 wherein said tendering step is carrying out by a centrifugal process.

4. A mass continuous production method according to claim 2 wherein said tendering step is carried out by squeezing said product by compression.

5. A mass continuous production method according to claim 2 wherein said tendering step is carried out by marinating said product with salt.

6. A mass continuous production method according to claim 3 wherein said hot water has a temperature of between 70 to 85° C.

7. A mass continuous production method according to claim 6 wherein said cooling and dehydrating step is carried out in cooling said product in a cooling chamber having a vacuum pressure of between 500 to 600 pascals.
